(19) United States
(12) Patent Application Publication
(10) Pub. No.: US 2025/0037065 A1
(43) Pub. Date: Jan. 30, 2025

(54) METHOD AND INTERNET OF THINGS (IOT) SYSTEM FOR TRANSPORTATION SAFETY SUPERVISION BASED ON SMART GAS

(71) Applicant: CHENGDU QINCHUAN IOT TECHNOLOGY CO., LTD., Chengdu (CN)

(72) Inventors: Zehua SHAO, Chengdu (CN); Bin LIU, Chengdu (CN); Feng WANG, Chengdu (CN)

(73) Assignee: CHENGDU QINCHUAN IOT TECHNOLOGY CO., LTD., Chengdu (CN)

(21) Appl. No.: 18/915,339

(22) Filed: Oct. 14, 2024

(30) Foreign Application Priority Data
Sep. 3, 2024 (CN) 202411228329.3

(51) Int. Cl. G06Q 10/0832; G16Y 10/35; G16Y 10/40; G16Y 40/10; G16Y 40/50

(52) U.S. Cl. CPC G06Q 10/0832; G16Y 10/35; G16Y 10/40; G16Y 40/10; G16Y 40/50

(57) ABSTRACT

The present disclosure provides a method and an Internet of Things (IoT) system for transportation safety supervision based on smart gas. The method is implemented by a government gas supervision and management platform, and comprises determining an estimated degree of risk of a gas transportation request; generating a candidate transportation request and a query instruction; obtaining gas transportation parameters of a currently supervised vehicle and road information at a preset frequency through the query instruction; determining a target transportation request, and generating a target instruction; executing the target transportation request through an execution instruction of the target instruction, and updating a total count of tasks through an update instruction; adjusting the preset frequency based on the latest total count of tasks; adjusting a gas transportation route of the target vehicle; and generating an adjustment instruction and control the target vehicle to execute an adjusted route.

### CROSS-REFERENCE TO RELATED APPLICATIONS

This application claims priority to Chinese Application No. 202411228329.3, filed on Sep. 3, 2024, the entire contents of which are incorporated herein by reference.

### TECHNICAL FIELD

The present disclosure relates to the field of gas transportation safety control, and in particular to a method and an Internet of Things (IoT) system for transportation safety supervision based on smart gas.

### BACKGROUND

Gas is a type of flammable and explosive dangerous goods, so it needs a specially designed gas transporting vehicle for transportation. The gas transporting vehicle can flexibly dispatch and transport gas products. Incorrect operation or accidents during gas transportation may cause gas leakage, fire or explosion and other safety accidents. The gas transporting vehicle should be kept away from institutions, schools, warehouses and crowded places, and the process of gas transportation needs to be supervised.

Therefore, a method and an Internet of Things (IoT) system for transportation safety supervision based on smart gas are provided to enhance the supervision effect of the transportation process of the gas transporting vehicle.

### SUMMARY

One of the embodiments of the present disclosure provides a method for transportation safety supervision based on smart gas, implemented by a government gas supervision and management platform. The method may comprise: determining an estimated degree of risk of a gas transportation request based on the gas transportation request uploaded by a gas company management platform, the gas transportation request including a gas transportation route, a transportation time, and a transportation volume; in response to determining that the estimated degree of risk satisfies a preset risk condition, determining the gas transportation request as a candidate transportation request and generating a query instruction; sending the query instruction to the gas company management platform for execution, the query instruction being configured to control at least one monitoring device controlled by the gas company management platform to obtain gas transportation parameters of a currently supervised vehicle and road information at a preset frequency; the gas transportation parameters including at least one of a total count of tasks and a vehicle location of a transporting vehicle; determining a target transportation request based on the candidate transportation request, the gas transportation parameters of the currently supervised vehicle, and the road information corresponding to the currently supervised vehicle, and generating a target instruction, the target instruction including at least one of an execution instruction and an update instruction; sending the target instruction to the gas company management platform for execution, the execution instruction being configured to execute the target transportation request, and the update instruction being configured to update the total count of tasks to obtain the latest total count of tasks; adjusting the preset frequency based on the latest total count of tasks to obtain an adjusted frequency and sending the adjusted frequency to a government gas supervision object platform for execution; in response to determining that a target vehicle exists and the road information corresponding to the target vehicle satisfies a preset road condition, adjusting the gas transportation route of the target vehicle to obtain an adjusted route and generating an adjustment instruction; and sending the adjustment instruction to a gas equipment object platform for execution, the adjustment instruction being configured to control the target vehicle to execute the adjusted route.

One of the embodiments of the present disclosure provides an Internet of Things (IoT) system for transportation safety supervision based on smart gas. The IoT system may comprise a public user platform, a citizen cloud service platform, a government gas supervision and management platform, a government gas supervision sensor network platform, a government gas supervision object platform, a gas company sensor network platform, and a gas equipment object platform. The government gas supervision object platform may include a gas company management platform. The government gas supervision and management platform may be configured to: determine an estimated degree of risk of a gas transportation request based on a gas transportation request uploaded by the gas company management platform, the gas transportation request including a gas transportation route, a transportation time, and a transportation volume; in response to determining that the estimated degree of risk satisfies a preset risk condition, determine the gas transportation request as a candidate transportation request and generate a query instruction; send the query instruction to the government gas supervision object platform for execution, the query instruction being configured to control at least one monitoring device controlled by the gas company management platform to obtain gas transportation parameters of a currently supervised vehicle and road information at a preset frequency; the gas transportation parameters including at least one of a total count of tasks and a vehicle location of a transporting vehicle; determine a target transportation request based on the candidate transportation request, the gas transportation parameters of the currently supervised vehicle, and the road information corresponding to the currently supervised vehicle, and generate a target instruction, the target instruction including at least one of an execution instruction and an update instruction; send the target instruction to the gas company management platform for execution, the execution instruction being configured to execute the target transportation request, and the update instruction being configured to update the total count of tasks to obtain the latest total count of tasks; adjust the preset frequency based on the latest total count of tasks to obtain an adjusted frequency and send the adjusted frequency to the government gas supervision object platform for execution; in response to determining that a target vehicle exists and the road information corresponding to the target vehicle satisfies a preset road condition, adjust the gas transportation route of the target vehicle to obtain an adjusted route and generate an adjustment instruction; and send the adjustment instruction to the gas equipment object platform for execution, the adjustment instruction being configured to control the target vehicle to execute the adjusted route. The gas company management platform may be configured to: obtain the gas transportation request; execute the query instruction to control the at least one monitoring device to obtain the gas transportation parameters of the currently supervised vehicle and the road information at the preset frequency; and execute the target instruction to execute the target transportation request and update the total count of tasks to obtain the latest total count of tasks. The gas company senso network platform may be configured to transmit the adjustment instruction to the gas equipment object platform. The gas equipment object platform may be configured to control the target vehicle to execute the adjusted route.

The present disclosure has the following beneficial effects. According to the embodiments of the present disclosure, the government gas supervision and management platform is configured to determine the estimated degree of risk of the gas transportation request, generate the candidate transportation request, determine the target transportation request and the target instruction based on the candidate transportation request, the gas transportation parameters of the currently supervised vehicle, and the road information, update the total count of tasks, and adjust the preset frequency; and adjust the gas transportation route of the target vehicle. The safe and reasonable gas transportation route can be intelligently determined, and the integrated transportation of a plurality of gas companies can be supervised at the same time, thereby improving the gas transportation efficiency, and reducing the risk of gas transportation.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic structural diagram illustrating an Internet of Things (IoT) according to some embodiments of the present disclosure;

FIG. 2 is a flowchart illustrating an exemplary method for transportation safety supervision based on smart gas according to some embodiments of the present disclosure;

FIG. 3 is a schematic diagram illustrating an exemplary risk prediction model according to some embodiments of the present disclosure;

FIG. 4 is a flowchart illustrating an exemplary process of determining a target transportation request according to some embodiments of the present disclosure; and

FIG. 5 is a schematic diagram illustrating an exemplary temporal model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system”, “device”, “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one”, “a”, “an”, “one kind”, and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure, and the related descriptions are provided to aid in a better understanding of the magnetic resonance imaging method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

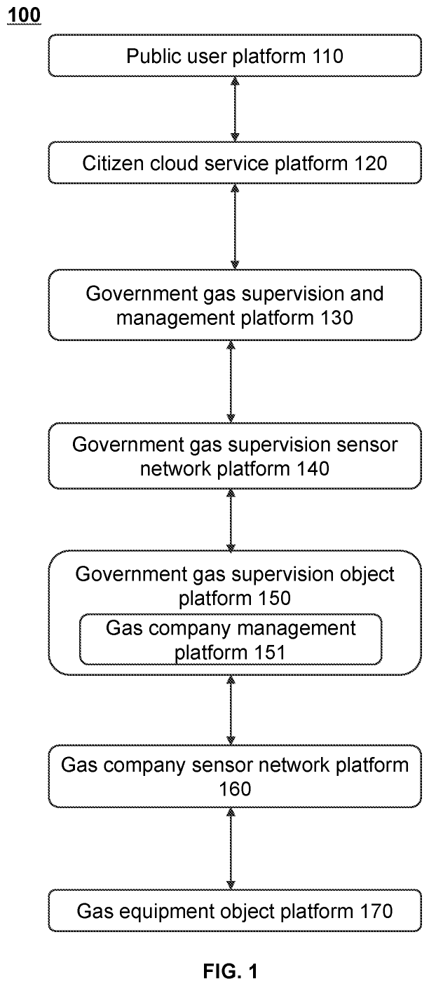

FIG. 1 is a schematic structural diagram illustrating an Internet of Things (IoT) according to some embodiments of the present disclosure. As shown in FIG. 1, an Internet of Things (IoT) system 100 for transportation safety supervision based on smart gas may include a public user platform 110, a citizen cloud service platform 120, a government gas supervision and management platform 130, a government gas supervision sensor network platform 140, a government gas supervision object platform 150, a gas company sensor network platform 160, and a gas equipment object platform 170.

The public user platform 110 refers to a platform used to interface with people users (e.g., all citizens). In some embodiments, the public user platform 110 may serve as a user platform for a smart gas primary network.

The citizen cloud service platform 120 refers to a platform for providing cloud services for the citizens. In some embodiments, the citizen cloud service platform 120 may serve as a service platform for the smart gas primary network. In some embodiments, the citizen cloud service platform 120 may perform data interaction with the public user platform 110 and the government gas supervision and management platform 130.

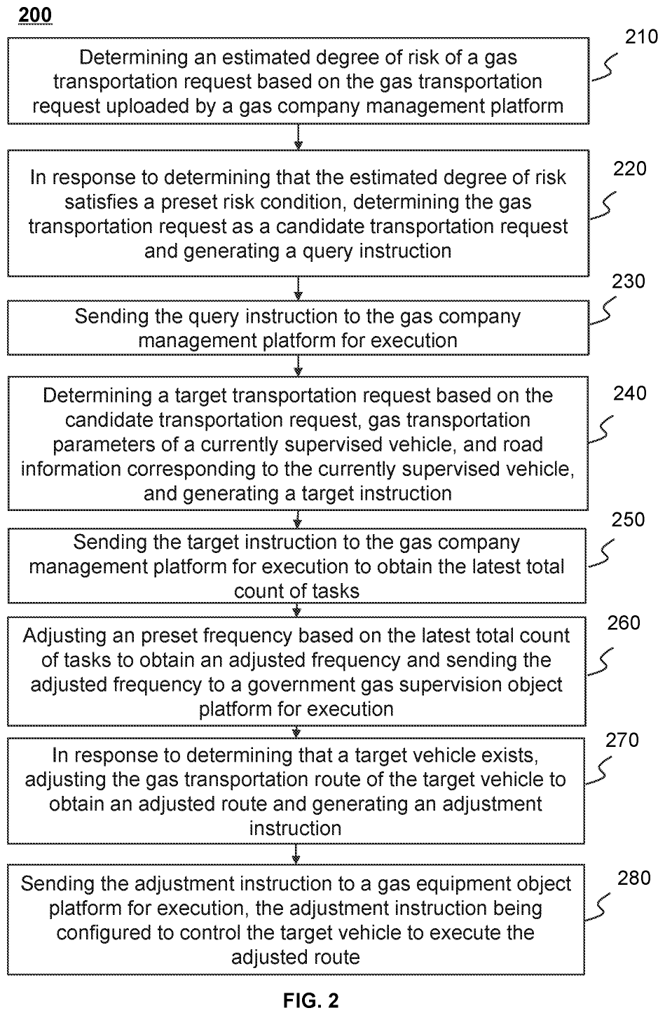

The government gas supervision and management platform 130 refers to a platform that provides gas supervision and management functions for a government department. In some embodiments, the government gas supervision and management platform 130 may serve as a management platform for the smart gas primary network and/or a user platform for a smart gas secondary network. The smart gas primary network may serve as a superior management network of the smart gas secondary network. In some embodiments, the government gas supervision and management platform 130 may be configured to perform the method for transportation safety supervision based on smart gas. More descriptions regarding the method for transportation safety supervision based on smart gas may be found in FIG. 2 and related descriptions thereof.

The government gas supervision sensor network platform 140 refers to a network platform for performing information transmission between the government gas supervision object platform 150 and the government gas supervision and management platform 130. In some embodiments, the government gas supervision sensor network platform 140 may serve as a sensor network platform for the smart gas primary network and/or a service platform for the smart gas secondary network. In some embodiments, the government gas supervision sensor network platform 140 may perform data interaction with the government gas supervision and management platform 130 and the gas company management platform 151.

The government gas supervision object platform 150 refers to a platform corresponding to a gas object that is regulated by the government department. In some embodiments, the government gas supervision object platform 150 may serve as an object platform for the smart gas primary network and/or a management platform for the smart gas secondary network. In some embodiments, the government gas supervision object platform 150 may include a gas company management platform 151.

The gas company management platform 151 refers to a platform that provides management functions for a gas company. In some embodiments, the gas company management platform 151 may be configured to obtain a gas transportation request, execute a query instruction to control at least one monitoring device to obtain gas transportation parameters of a currently supervised vehicle and road information at a preset frequency, execute a target instruction to execute a target transportation request and update a total count of tasks to obtain the latest total count of tasks.

The gas company sensor network platform 160 refers to a network platform for performing information transmission between the gas company management platform 151 and the gas equipment object platform 170. In some embodiments, the gas company sensor network platform 160 may serve as a sensor network platform for the smart gas secondary network. In some embodiments, the gas company sensor network platform 160 may perform data interaction with the gas company management platform 151 and the gas equipment object platform 170. In some embodiments, the gas company sensor network platform 160 may be configured to transmit an adjustment instruction to the gas equipment object platform.

The gas equipment object platform 170 refers to a platform corresponding to a gas equipment object. In some embodiments, the gas equipment object platform 170 may serve as an object platform for the smart gas secondary network. In some embodiments, the gas equipment object platform 170 may be configured to control a target vehicle to execute an adjusted route.

More descriptions regarding the functions of the above platforms may be found in the related descriptions of FIGS. 2-5.

By constructing the IoT system 100 for transportation safety supervision based on smart gas, the data with high accuracy and real time performance can be provided for the execution of the method for transportation safety supervision based on smart gas by effectively using the data collection and the interaction capability of the IoT platform, thereby improving the reliability of transportation safety supervision based on smart gas.

FIG. 2 is a flowchart illustrating an exemplary method for transportation safety supervision based on smart gas according to some embodiments of the present disclosure. In some embodiments, a process 200 may be performed by a government gas supervision and management platform. As shown in FIG. 2, the process 200 may include the following operations.

In 210, an estimated degree of risk of a gas transportation request may be determined based on the gas transportation request uploaded by a gas company management platform.

The gas transportation request refers to request data related to a demand for gas transportation of a gas company. For example, the gas transportation request may include information such as a gas transportation route, a transportation time, a transportation volume, or the like.

In some embodiments, the government gas supervision and management platform may obtain the gas transportation request uploaded by the gas company from a gas company management platform based on a government gas supervision sensor network platform.

The gas transportation route refers to a transportation route of gas. For example, the gas transportation route may include a transportation start point and a transportation end point.

The transportation time refers to time when the gas is transported. For example, the transportation time may be a time point at which the execution of the gas transportation request is expected to begin or a time point at which the gas is expected to be transported to the transportation end point, etc.

The transportation volume refers to information characterizing the amount of gas transported. For example, the transportation volume may be a count of cylinders of gas in cylinders.

In some embodiments, the gas transportation request may further include a speed threshold corresponding to the gas transportation route. The speed threshold may be determined based on the transportation volume, composition information of the transported gas, a degree of road bumps, and a storage volume of a transporting vehicle.

The composition information of the transported gas refers to information about relevant proportions of various gases in the transported gas. For example, the composition information of the transported gas may be a ratio of the contents or a ratio of the volumes of various gaseous components of the gas. In some embodiments, the composition information of the transported gas may be obtained from the gas company management platform based on the government gas supervision sensor network platform.

The degree of road bumps refers to a degree of unevenness of the road of the gas transportation route. For example, the degree of road bumps may be categorized as level, slight, moderate, significant, or severe. For example, the degree of road bumps may also be expressed in the form of scores.

In some embodiments, the government gas supervision and management platform may obtain the degree of road bumps of the gas transportation route in various ways.

For example, a plurality of route points may be determined on the gas transportation route based on a preset length. The government gas supervision and management platform may set a route distance between two neighboring route points of the plurality of route points as a preset length. Heights of the plurality of the route points relative to the same horizontal plane may constitute a height sequence. A height change of a road of the gas transportation route may be determined based on the constituted height sequence. The height change may include a maximum height difference and a standard deviation of height.

The degree of road bumps may be determined through a preset relationship based on the height change, a count of speed bumps, a count of zebra crossings, and a count of traffic lights on the gas transportation route. In the preset relationship, the larger the maximum height difference, the larger the standard deviation of height, the more the count of speed bumps, the more the count of zebra crossings, and the more the count of traffic lights, the higher the degree of road bumps.

The storage volume of the transporting vehicle refers to an amount of space inside the transporting vehicle used for item storage. In some embodiments, the storage volume of the transporting vehicle may be obtained from the gas company management platform based on the government gas supervision sensor network platform.

The speed threshold refers to an upper limit of the transportation speed. The maximum speed value of the transportation speed may not exceed the speed threshold. In some embodiments, the government gas supervision and management platform may obtain the speed threshold by the following operations.

First, a first vector database may be constructed. The first vector database may include a plurality of reference vectors, and a reference speed corresponding to each of the plurality of reference vectors, and a reference accident situation.

In some embodiments, the plurality of reference vectors may be constructed based on a count of cylinders of gas actually transported, composition information of the gas actually transported, a historical degree of road bumps, and a historical storage volume of the transporting vehicle in historical transportation.

In some embodiments, the reference speed corresponding to each of the plurality of reference vectors refers to an average speed of the transporting vehicle in the historical transportation.

In some embodiments, the reference accident situation may be determined based on a historical actual accident condition in the historical transportation. For example, the reference accident situation may include whether an accident occurs and a type of the accident that occurs and a hazard score. The type of accident may include a gas leakage and a degree of leakage, a gas explosion, etc. The hazard score may be determined by scoring each type of accident in advance. For example, the hazard score may be determined by manual labeling. The hazard score corresponding to when no accident occurs may be a preset value, such as 0, etc.

Second, a first target feature vector may be constructed based on a count of cylinders of gas currently transported, the composition information of the transported gas, the degree of road bumps, and the storage volume of the transporting vehicle. Reference vectors satisfying a preset condition may be matched in the first vector database based on the first target feature vector, and recorded as first vectors. If a plurality of reference vectors satisfy the preset condition, a plurality of first vectors may exist accordingly. In some embodiments, the preset condition may be that a vector distance is less than a first distance threshold, and the vector distance may be a Euclidean distance, a cosine distance, or the like.

Third, second vectors may be selected from the first vectors based on the reference accident situations corresponding to the first vectors.

In some embodiments, the government gas supervision and management platform may determine first vectors of which the reference accident situations indicate the occurrence of accident as the second vectors. A composite hazard score of the first target feature vector may be counted, and the composite hazard score may be equal to a sum of the hazard scores of all the second vectors.

Fourth, a plurality of reference speeds corresponding to the plurality of the second vectors may be weighted and averaged based on a weight sequence to obtain the speed threshold.

For example, the speed threshold may be a weighted sum of the plurality of the reference speeds and weights corresponding to the plurality of reference speeds.

The weight sequence may include the weights corresponding to each of the plurality of reference speeds in turn. The weights corresponding to the plurality of reference speeds may be positively correlated with the hazard scores of the second vectors corresponding thereto.

For example, the government gas supervision and management platform may calculate the weights corresponding to the plurality of reference speeds by using equation (1):

$$X = P \div Z \times 100 \% ; \qquad ( 1 )$$

wherein X denotes the weight corresponding to each of the plurality of reference speeds, P denotes the hazard score of each second vector corresponding to each of the plurality of reference speeds, and Z denotes the composite hazard score.

In some embodiments, if all the reference accident situations corresponding to the first vectors indicate no accident, the largest reference speed of the plurality of reference speeds corresponding to the first vectors may be used as the speed threshold.

The greater the degree of road bumps and the greater the count of cylinders of gas in cylinder, the more likely the vehicle is to experience the following during traveling: first, the friction between the cylinders and between the cylinders and the vehicle body increases, which may easily cause heating up to generate sparks; and second, the cylinders are more likely to be damaged by impact and crushing, which may easily cause gas leakage. If the gas leakage reaches a certain concentration and the friction causes heating up to generate sparks, it leads to the explosion. According to some embodiments of the present disclosure, setting the speed threshold may control the speed of gas transportation to be within a certain range, thereby reducing the bumps and reducing the risk of gas explosion.

The estimated degree of risk refers to a probability that a gas incident may occur in the future when the gas transportation request is executed.

In some embodiments, the government gas supervision and management platform may obtain the estimated degree of risk by the following operations.

First, a second vector database may be constructed. The second vector database may include a plurality of reference vectors, and a reference accident situation corresponding to each of the plurality of reference vectors.

In some embodiments, the plurality of the reference vectors may be constructed based on a plurality of historical gas transportation requests. The reference accident situation corresponding to each of the plurality of reference vectors refers to a historical actual accident condition of historical transportation corresponding to one of the plurality of historical gas transportation requests. More descriptions may be found in the related descriptions of the reference accident situation in the first vector database.

Second, a second target feature vector may be constructed based on a current gas transportation request. Reference vectors that satisfy a preset condition may be matched in the second vector database based on the second target feature vector, and recorded as third vectors. A plurality of third vectors may be provided. In some embodiments, the preset condition may be that the vector distance is less than a second distance threshold. The vector distance may be the Euclidean distance, the cosine distance, or the like.

Third, the estimated degree of risk of the second target feature vector may be calculated based on the reference accident situations corresponding to the third vectors.

For example, the estimated degree of risk of the second target feature vector may be positively correlated with a sum of hazard scores of the third vectors of which the reference accident situations indicate the occurrence of accident, and negatively correlated with a sum of hazard scores of all the third vectors.

For example, the government gas supervision and management platform may calculate the estimated degree of risk of the second target feature vector by using equation (2):

$$Y = M \div N \times 100 \% ; \qquad ( 2 )$$

wherein Y denotes the estimated degree of risk of the second target feature vector, M denotes the sum of the hazard scores of the third vectors of which the reference accident situations indicate the occurrence of accident, and N denotes the sum of the hazard scores of all the third vectors. The descriptions regarding the hazard scores may be the same as that described above for the hazard scores regarding obtaining the speed threshold, and may be found in the related descriptions regarding obtaining the speed threshold above.

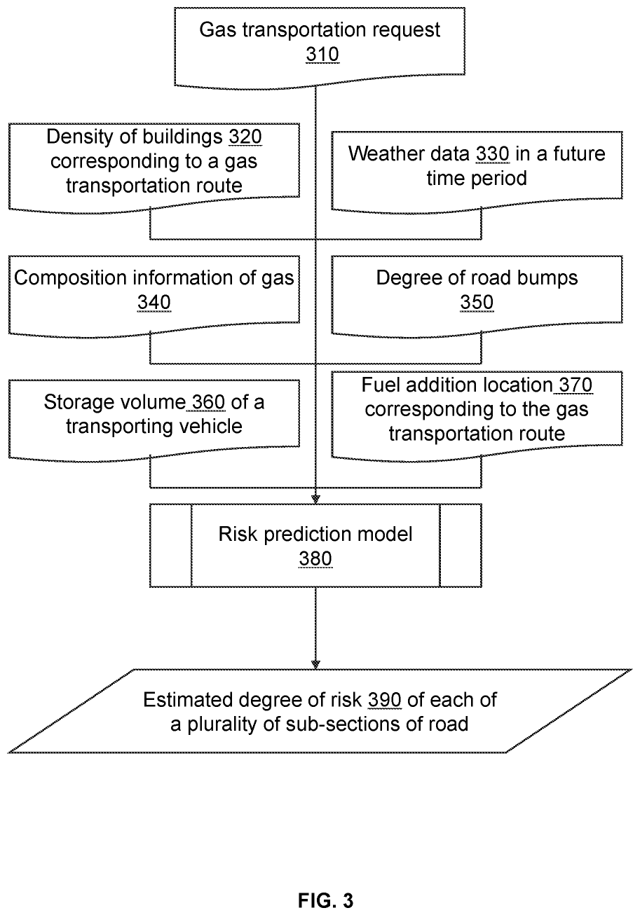

More descriptions regarding obtaining the estimated degree of risk may be found in FIG. 3 and related descriptions thereof.

In some embodiments, the gas transportation request may include a plurality of distribution destinations and a sub-distribution volume corresponding to each of the plurality of distribution destinations.

In some embodiments, one of the plurality of distribution destinations may correspond to one of a plurality of sub-sections of road. The government gas supervision and management platform may determine an estimated degree of risk of each of plurality of sub-sections of road based on the gas transportation request.

The distribution destination refers to a location in the gas transportation route where the gas transporting vehicle stops and supplies gas. For example, the gas in cylinders loaded on the gas transporting vehicle need to be distributed to a plurality of locations A, B, and C through current gas transportation, and a portion of the gas in cylinders may be unloaded at each of the plurality of locations A, B, and C. The plurality of locations A, B, and C may correspond to the plurality of the distribution destinations.

The sub-distribution volume refers to the amount of gas supplied by the gas transporting vehicle at each of the plurality of the distribution destinations. For example, the sub-distribution volume may be a count of cylinders of the gas in cylinders unloaded at the distribution destination.

The sub-section of road refers to a route of the gas transporting vehicle from the gas transportation start point or a previous distribution destination to a next distribution destination.

The estimated degree of risk of each of the plurality of sub-sections of road refers to a probability that the gas transporting vehicle may have a gas accident on the sub-section of road.

In some embodiments, the government gas supervision and management platform may determine the estimated degree of risk of each of the plurality of sub-sections of road in various ways. For example, the government gas supervision and management platform may use a historical accident probability of each of the plurality of sub-sections of road as the estimated degree of risk of the sub-section. More descriptions regarding determining the estimated degree of risk of each of the plurality of sub-sections of road may be found in FIG. 3 and related descriptions thereof.

In some embodiments, the government gas supervision and management platform may use a sum of the estimated degrees of risk of all the sub-sections as an estimated degree of risk of a corresponding gas transportation request.

The estimated degree of risk of each of the plurality of sub-sections of road may be determined by subdividing the gas transportation requests, matching the plurality of sub-sections of road, and risk evaluation, such that the risk of the entire gas transportation process can be more comprehensively understood, and the risk can be reduced when needed by taking appropriate measures, thereby realizing the more refined gas transportation management, and improving the safety and efficiency of gas transportation.

In 220, in response to determining that the estimated degree of risk satisfies a preset risk condition, the gas transportation request may be determined as a candidate transportation request and a query instruction may be generated.

The preset risk condition refers to a risk limit condition set in advance. For example, the preset risk condition may be that the estimated degree of risk is less than a first risk threshold.

The candidate transportation request refers to a pending gas transportation request.

The query instruction refers to an instruction for retrieving information from a data source. More descriptions regarding the query instruction may be found in the related descriptions of operation 230.

In some embodiments, in response to determining that the estimated degree of risk does not satisfy the preset risk condition, the government gas supervision and management platform may generate a feedback instruction and send the feedback instruction to the gas company management platform for execution. The feedback instruction may be configured to notify an execution object to upload a new gas transportation request.

The execution object refers to an object for uploading the gas transportation request. For example, the execution object may be a gas company that the estimated degree of risk of the uploaded gas transportation request does not satisfy the preset risk condition.

In response to determining that the estimated degree of risk does not satisfy the preset risk condition, the feedback instruction may be generated and sent to the gas company management platform for execution. The gas company management platform may notify, based on the feedback, the gas company to adjust the gas transportation request in time to satisfy the preset risk condition, thereby ensuring the safety and reliability of gas transportation.

In 230, the query instruction may be sent to the gas company management platform for execution.

The query instruction may be configured to control at least one monitoring device controlled by the gas company management platform to obtain gas transportation parameters of a currently supervised vehicle and road information at a preset frequency. In some embodiments, the government gas supervision and management platform may send the query instruction to the government gas supervision object platform based on the government gas supervision sensor network platform, and the government gas supervision object platform may send the query instruction to the gas company management platform to control the at least one monitoring device controlled the gas company management platform to execute the corresponding query instruction and obtain the gas transportation parameters of the currently supervised vehicle and the road information at the preset frequency.

The at least one monitoring device refers to a device for monitoring a target parameter. For example, the at least one monitoring device may be a positioning device, a monitoring device with electronic map functions, or the like.

The preset frequency refers to a frequency value that is set in advance for collecting the gas transportation parameters of the currently supervised vehicle and the road information. For example, the preset frequency may be a frequency value of collecting the gas transportation parameters of the currently supervised vehicle and the road information every 5 minutes.

The currently supervised vehicle refers to a transporting vehicle performing a gas transportation task.

The gas transportation parameters refer to parameters related to the gas transportation process. For example, the gas transportation parameters may include a total count of tasks and/or a vehicle location of the transporting vehicle, etc.

The total count of tasks refers to a total count of gas transportation tasks. For example, one gas transportation request may correspond to one gas transportation task to be performed by one transporting vehicle, and the total count of tasks may be a count of the currently supervised vehicles.

The vehicle location of the transporting vehicle refers to a geographical location of the gas transporting vehicle at a particular time (e.g., real time). For example, the vehicle location of the transporting vehicle may be location information represented in longitude and latitude coordinates.

The road information may include a congestion situation, a traffic accident situation, etc., on the road of the gas transportation route. The traffic accident situation may be whether the road has a traffic accident, a count of traffic accidents and the severity thereof, etc., in a current or historical time period.

In some embodiments, the government gas supervision and management platform may obtain the congestion situation of the gas transportation route through a real-time electronic map, or the like. For example, the government gas supervision and management platform may set a length of a congested road within a preset distance ahead of the vehicle location of the transporting vehicle as the congestion situation of the gas transportation route.

In some embodiments, whether the road has a traffic accident refers to whether a traffic accident occurs on the gas transportation route during a preset time period. The preset time period may be within the past 3 hours, and the traffic accident may be a car accident, a road collapse, or the like.

The severity of a traffic accident refers to a degree of damage and impact caused by the traffic accident. In some embodiments, the government gas supervision and management platform may preset a criterion for the severity of the traffic accident. For example, the government gas supervision and management platform may determine the severity of the traffic accident based on the casualties through the preset criterion. The preset criterion may be characterized based on a first preset table including a correspondence between the casualties and the severity of the traffic accident. In some embodiments, the severity of the traffic accident may be on a scale of 1 to 10.

In 240, a target transportation request may be generated based on the candidate transportation request, the gas transportation parameters of the currently supervised vehicle, and the road information corresponding to the currently supervised vehicle, and a target instruction may be generated.

The target transportation request refers to a gas transportation request to be executed. In some embodiments, the government gas supervision and management platform may determine, based on the candidate transportation request, the gas transportation parameters of the currently supervised vehicle, and the road information corresponding to the currently supervised vehicle, the target transportation request through a second preset table. The second preset table may include a correspondence between the target transportation request, the candidate transportation request, the transportation parameters of the currently supervised vehicle, and the road information corresponding to the currently supervised vehicle.

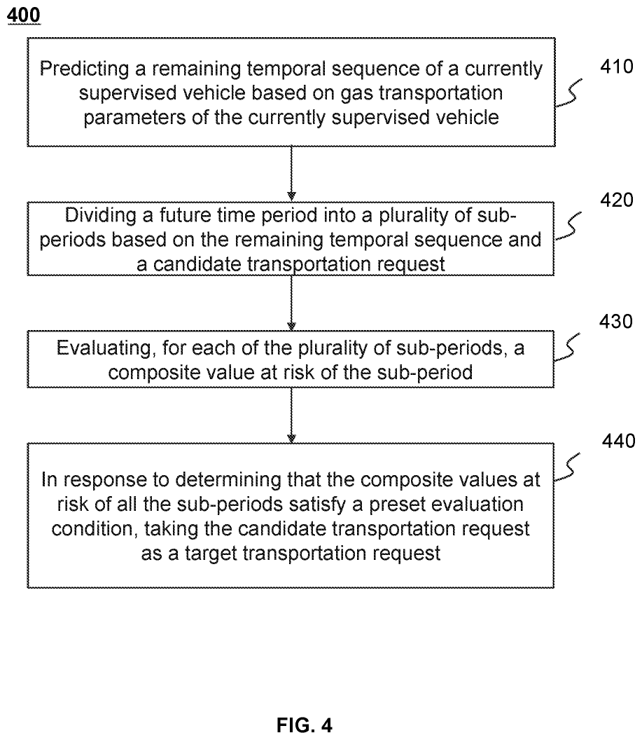

More descriptions regarding determining the target transportation request may be found in FIG. 4 and related descriptions thereof.

The target instruction refers to an instruction for realizing a corresponding target. For example, a target instruction may include an execution instruction and/or an update instruction. More descriptions regarding the execution instruction and the update instruction may be found in operation 250 and related descriptions thereof.

In 250, the target instruction may be sent to the gas company management platform for execution to obtain the latest total count of tasks.

Sending the target instruction to the gas company management platform for execution may include sending the execution instruction and the update instruction to the gas company management platform for execution. The execution instruction may be configured to instruct the gas company management platform to control the transporting vehicle to execute the target transportation request. The update instruction n may be configured to instruct the gas company management platform to update the total count of tasks. The gas company management platform controlling the transporting vehicle to execute the target transportation request may be performed by the gas company management platform sending the execution instruction to the gas equipment object platform based on the gas company sensor network platform. After the execution instruction is received, the gas equipment object platform may control a corresponding transporting vehicle (e.g. a current idle transporting vehicle, etc.) to execute a corresponding target transportation request.

The latest total count of tasks refers to an updated total count of gas transportation tasks. For example, the latest total count of tasks may be an updated count of currently supervised vehicles. Merely by way of example, the latest total count of tasks may be equal to a total count of current tasks plus a count of tasks corresponding to the target transportation request.

In 260, the preset frequency may be adjusted based on the latest total count of tasks to obtain an adjusted frequency and the adjusted frequency may be sent to a government gas supervision object platform for execution.

In some embodiments, the government gas supervision and management platform may adjust the preset frequency based on the latest total count of tasks through a preset correspondence.

In some embodiments, the preset correspondence refers to that the latest total count of tasks is positively correlated with the preset frequency. That is, the greater the latest total count of tasks, the greater the risk of accident in the transportation process. In this case, the supervision of the currently supervised vehicle may be enhanced by, for example, increasing the preset frequency of obtaining the information, so as to adjust the transportation in time and reduce the risk.

In 270, In response to determining that a target vehicle exists, the gas transportation route of the target vehicle may be adjusted to obtain an adjusted route and an adjustment instruction may be generated.

The target vehicle refers to a vehicle of which the road information satisfies a preset road condition. More descriptions regarding the road information may be found in the related descriptions of the operation 230.

The preset road condition refers to a preset condition that need to be satisfied by the road information. For example, the preset road condition may be that the length of the congested road within the preset distance ahead of the vehicle location of the transporting vehicle may be greater than a first threshold; or the count of traffic accidents on the gas transportation route during the preset time period may be greater than a second threshold; or a sum of the severity of all traffic accidents occurring on the gas transportation route during the preset time period may be greater than a third threshold. The first threshold, the second threshold, and the third threshold value may be preset values.

In some embodiments, when the target vehicle exists, the government gas supervision and management platform may adjust the gas transportation route of the target vehicle to obtain the adjusted route, and generate the adjustment instruction. For example, the government gas supervision and management platform may determine a route with a minimum congestion situation as a new gas transportation route, i.e., the adjusted route. The minimum congestion situation may be that the length of the congested road within the preset distance ahead of the vehicle location of the transporting vehicle is minimum.

After the adjusted route is determined, the government gas supervision and management platform may generate the corresponding adjustment instruction based on the adjusted route.

In 280, the adjustment instruction may be sent to a gas equipment object platform for execution, the adjustment instruction being configured to control the target vehicle to execute the adjusted route.

The government gas supervision and management platform may send the adjustment instruction to the gas equipment object platform through the government gas supervision sensor network platform, the government gas supervision object platform, and the gas company sensor network platform, respectively, to control the target vehicle to execute the adjusted route based on the gas equipment object platform according to the adjustment instruction.

FIG. 3 is a schematic diagram illustrating an exemplary risk prediction model according to some embodiments of the present disclosure. In some embodiments, a government gas supervision and management platform may determine, based on a gas transportation request 310, a density of buildings 320 corresponding to a gas transportation route, weather data 330 in a future time period, composition information of gas 340, a degree of road bumps 350, and a storage volume 360 of a transporting vehicle, an estimated degree of risk 390 of each of a plurality of sub-sections of road through a risk prediction model 380. The risk prediction model 380 may be a machine learning model.

More descriptions regarding the gas transportation request 310 may be found in FIG. 2 and related descriptions thereof.

The density of buildings 320 corresponding to the gas transportation route may be characterized based on types and a count of buildings surrounding the road of the transportation route at various preset lengths.

In some embodiments, the government gas supervision and management platform may divide the gas transportation route into a plurality of road sections based on the preset length, and obtain the types and the count of buildings on each of the plurality of road sections through an electronic map. For different types of buildings in the corresponding count, different density scores may be preset, and then the density scores of all buildings on the road section may be added up as the density of the road section, and finally a sequence of the density scores of all the road sections may be formed to obtain the density of buildings 320 corresponding to the gas transportation route.

The weather data 330 in the future time period refers to data on weather conditions in the future time period. The future time period may be determined based on time when the transporting vehicle executes the transportation request. In some embodiments, the weather data 330 in the future time period may be obtained by querying a weather forecast, etc.

More descriptions regarding the composition information of gas 340, the degree of road bumps 350, and the storage volume 360 of the transporting vehicle may be found in FIG. 2 and related descriptions thereof.

The risk prediction model 380 refers to a model configured to predict an estimated degree of risk of each of the plurality of sub-sections of road. In some embodiments, the risk prediction model 380 may be a machine learning model, such as a deep-learning neural network (DNN) and/or support vector machines (SVMs), etc. An input of the model may include the gas transportation request 310, the density of buildings 320 corresponding to the gas transportation route, the weather data 330 in the future time period, the composition information of gas 340, the degree of road bumps 350, and the storage volume 360 of the transporting vehicle, and an output of the model may include the estimated degree of risk 390 of each of the plurality of sub-sections of road.

More descriptions regarding the estimated degree of risk 390 of each of the plurality of sub-sections of road may be found in FIG. 2 and related descriptions thereof.

In some embodiments, the risk prediction model 380 may be trained by supervised learning. For example, a plurality of training samples with labels may be input into an initial risk prediction model. A loss function may be constructed from the labels and results of the initial risk prediction model. Parameters of the initial risk prediction model may be iteratively updated based on the loss function via gradient descent or other modes. The model training may be completed when a preset condition is satisfied, and a trained risk prediction model may be obtained. The preset conditions may be that the loss function converges, a count of iterations reaches a threshold, etc.

The training samples may include a sample gas transportation request, a density of buildings corresponding to the gas transportation route, weather data at the time of executing the sample gas transportation request, composition information of gas being transported based on the sample gas transportation request, a degree of road bumps corresponding to the gas transportation route, and the storage volume of the transporting vehicle. The labels of the samples may be constructed based on historical actual traffic accidents on various sub-sections of the gas transportation route when the sample gas transportation request is executed. The historical actual traffic accidents may include traffic accidents involving different types of vehicles.

In some embodiments, the labels may be calculated by (a sum of the severity scores of the traffic accidents on the sub-sections)+ (a count of traffic accidents on the sub-sections×the maximum grade of the severity scores of the traffic accidents). More descriptions regarding determining the severity of the traffic accident may be found in FIG. 2 and related descriptions thereof.

For example, for a sample gas transportation request AD, a route AD may be divided into three sub-sections AB, BC, and CD. If the sub-section AB has no traffic accident, a training label corresponding to the sub-section AB may be 0. If the sub-section BC has two traffic accidents with the severity scores of grade 1 and grade 5, and the maximum grade of the severity score of the traffic accident is 10, a training label corresponding to the sub-section BC may be 30% ((1+5)÷(2×10)). If the sub-section CD has three traffic accidents with the severity scores of grade 1, grade 2 and grade 1, respectively, a training label corresponding to the sub-section CD may be 13.33% ((1+2+1)÷(3×10)). In summary, the training label corresponding to the sample gas transportation request AD may be (0, 30%, 13.33%).

In some embodiments, an input of the risk prediction model 380 may include a fuel addition location 370 corresponding to the gas transportation route. The fuel addition location 370 corresponding to the gas transportation route refers to a location on the gas transportation route where the transporting vehicle requires to stop and add fuel.

In some embodiments, when the input of the risk prediction model 380 includes the fuel addition location 370 corresponding to the gas transportation route, the training samples may include a fuel addition location corresponding to the sample gas transportation route.

By inputting the fuel addition location 370 corresponding to the gas transportation route into the risk prediction model 380, the risk caused by fuel addition to the transportation process can be adequately considered, thereby improving the accuracy of model prediction.

By constructing and training the risk prediction model 380, the impacts of the gas transportation request, the density of buildings corresponding to the gas transportation route, the weather data in the future time period, the composition information of gas, the degree of road bumps, and the storage volume of the transporting vehicles, etc. on the estimated degree of risk of each of the plurality of sub-sections of road can be explored, thereby improving the accuracy of the estimated degree of risk, saving the cost of manual determination, and providing reliable data support for the subsequent process.

FIG. 4 is a flowchart illustrating an exemplary process of determining a target transportation request according to some embodiments of the present disclosure. In some embodiments, a process 400 may be performed by a government gas supervision and management platform. As shown in FIG. 4, the process 400 may include the following operations.

In 410, a remaining temporal sequence of a currently supervised vehicle may be predicted based on gas transportation parameters of the currently supervised vehicle.

The remaining temporal sequence refers to a sequence consisting of remaining transportation time of each currently supervised vehicle. For example, the remaining temporal sequence refers to a sequence including the remaining transportation time of each currently supervised vehicle sorted in an ascending order.

The remaining transportation time refers to estimated time it takes for a gas transporting vehicle to reach a transportation end point from a current location. In some embodiments, the government gas supervision and management platform may obtain the remaining transportation time of an individual gas transporting vehicle in various ways. For example, the government gas supervision and management platform may obtain the remaining transportation time via an electronic map, etc. As another example, the government gas supervision and management platform may obtain the remaining transportation time based on a candidate transportation request, the gas transportation parameters of the currently supervised vehicle, and road information corresponding to the currently supervised vehicle through a third preset table or vector matching.

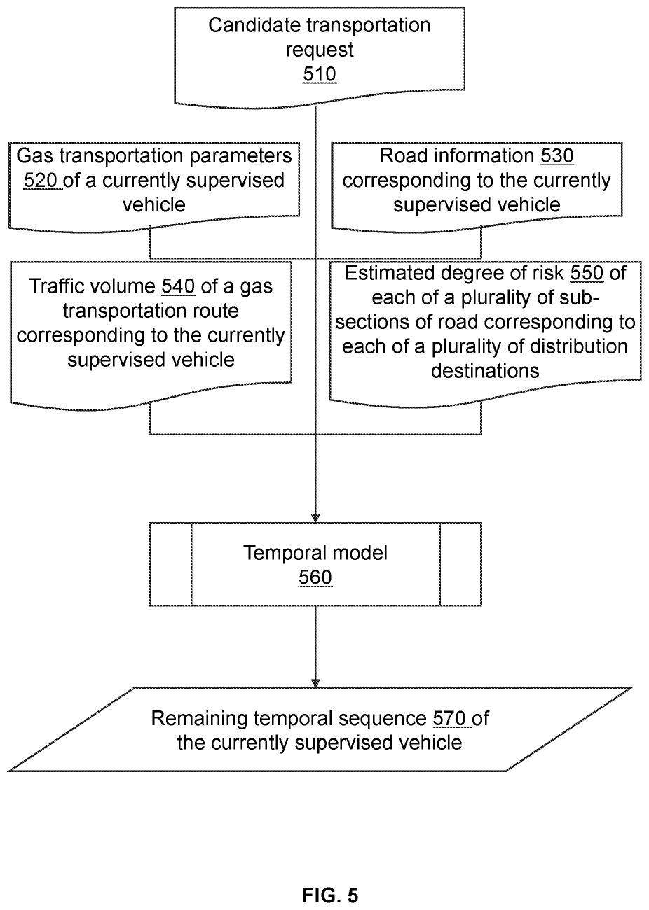

More descriptions regarding obtaining the remaining temporal sequence may be found in FIG. 5 and related descriptions thereof.

In 420, a future time period may be divided into a plurality of sub-periods based on the remaining temporal sequence and a candidate transportation request.

The future time period refers to a time period after the current time of the gas transporting vehicle. For example, the future time period may be the next 2 hours, etc. In some embodiments, the future time period may be preset. In some embodiments, the future time period may be determined based on the longest remaining transportation time in the remaining temporal sequence.

The plurality of sub-periods refer to time periods obtained by dividing the future time period. In some embodiments, the government gas supervision and management platform may determine at least one critical point based on end time of all the remaining transportation time in the remaining temporal sequence, and start time and end time of the candidate transportation request, and determine the plurality of sub-periods based on the at least one critical point.

In some embodiments, the government gas supervision and management platform may determine the start time of the candidate transportation request based on the transportation time of the candidate transportation request and the current time. For example, if the desired start time of transportation of the candidate transportation request is 10:30 p.m., and the current time is 10:00 p.m., the start time of the candidate transportation request is the 30th minute in the future. More descriptions regarding the transportation time may be found in the operation 210 and related descriptions thereof.

In some embodiments, the end time of the candidate transportation request may be determined based on the start time and reference transportation time of the candidate transportation request. The reference transportation time of the candidate transportation request refers to time required to complete the corresponding transportation, and may be determined based on a plurality of reference vectors in the operation 210. For example, if the plurality of reference vectors in the second vector database in the operation 210 correspond to the reference transportation time in addition to the reference accident situations, the government gas supervision and management platform may use an average value of the plurality reference transportation time corresponding to the plurality of third vectors that satisfy the preset condition in the second vector database as the reference transportation time of the candidate transportation request.

The end time of the candidate transportation request may be a sum of the start time of the candidate transportation request and the reference transportation time. For example, if the start time of the candidate transportation request is the 30th minute in the future, and the reference transportation time of the candidate transportation request is 40 minutes, the end time of the candidate transportation request may be the 70th minute in the future.

In some embodiments, the government gas supervision and management platform may use time that is within the future time period of the end time of all the remaining transportation time in the remaining temporal sequence, and the start time and the end time of the candidate transportation request as the critical point.

For example, there are a total of four transporting vehicles a, b, c, and d that are currently performing a task, the future time period may be one hour in the future, and the remaining transportation time corresponding to the transporting vehicles a, b, c, and d may be 35 minutes, 40 minutes, 60 minutes, and 75 minutes, respectively, i.e., the end time of the transportation requests corresponding to the transporting vehicles a, b, c, and d may be the 35th minute in the future, the 40th minute in the future, the 60th minute in the future, and the 75th minute in the future, respectively.

If the start time of a current candidate transportation request is the 30th minute in the future and the end time is the 70th minute in the future, the critical points may be the 30th minute in the future, the 35th minute in the future, the 40th minute in the future, and the 60th minute in the future.

The sub-periods obtained by dividing the future time period based on the critical points may be 0-30 minutes in the future, 30-35 minutes in the future, 35-40 minutes in the future, and 40-60 minutes in the future.

The transporting vehicles corresponding to the 0-30 minutes in the future may be the transporting vehicles a, b, c, and d. The transporting vehicles corresponding to the 30-35 minutes in the future may be the transporting vehicles a, b, c, and d and the transporting vehicle corresponding to the candidate transportation request. The transporting vehicles corresponding to the 35-40 minutes in the future may be the transporting vehicles b, c, and d and the transporting vehicle corresponding to the candidate transportation request. The transporting vehicles corresponding to the 40-60 minutes in the future may be the transporting vehicles c and d and the transporting vehicle corresponding to the candidate transportation request.

In some embodiments of the present disclosure, the critical point may be determined based on the end time of all the remaining transportation time in the future time period, and the start time and the end time of the candidate transportation request, and then the plurality of sub-periods may be obtained by dividing the future time period based on the critical point, such that the effect of the count of actual operating transporting vehicles on the occurrence of gas accidents in the entire gas transportation can be fully considered, the occurrence of the gas accidents in the future time period can be more accurately predicted, and the execution of the candidate transportation request can be adjusted in time when the risk of gas accidents in the future time period is predicted to be high, thereby reducing the risk of gas transportation.

In 430, for each of the plurality of sub-periods, a composite value at risk of the sub-period may be evaluated.

In some embodiments, the government gas supervision and management platform may weight and sum the estimated degree of risk of the transporting vehicle corresponding to the each of the plurality of sub-periods evaluated prior to the transportation to obtain the composite value at risk of the sub-period. A weight of the weighted sum may be positively correlated with the transportation volume of the transporting vehicle. More descriptions regarding obtaining the estimated degree of risk may be found in the operation 210 and related descriptions thereof.

In 440, in response to determining that the composite values at risk of all the sub-periods satisfy a preset evaluation condition, the candidate transportation request may be taken as a target transportation request.

The preset evaluation condition refers an evaluation condition set in advance. For example, the preset evaluation condition may be that the composite values at risk of all the sub-periods is less a second risk threshold. The composite value at risk of one sub-period may correspond to one preset evaluation condition, i.e., the composite value at risk of one sub-period may correspond to one second risk threshold. The second risk threshold may be different for different sub-periods.

In some embodiments, the second risk threshold may be correlated with the maximum time interval of the sub-period from the current time, and a count of currently supervised vehicles of the sub-period. The maximum time interval of the sub-period from the current time may be an interval between an end point of the sub-period and the current time. For example, if the sub-period is 35-40 minutes in the future, the maximum time interval of the sub-period from the current time may be 40 minutes.

In some embodiments, the government gas supervision and management platform may determine the second risk threshold through a preset relationship based on the maximum time interval of the sub-period from the current time, and the count of the currently supervised vehicles in the sub-period. In the preset relationship, the larger the maximum time interval of the sub-period from the current time, and the smaller the count of the currently supervised vehicles of the sub-period, the lower the second risk threshold.

In some embodiments, in response to determining that the composite value at risk of at least one sub-period does not satisfy the preset evaluation condition, the government gas supervision and management platform may refuse to execute the candidate transportation request and generate a second feedback instruction; and send the second feedback instruction to the gas company management platform for execution.

The second feedback instruction refers to a control instruction issued by the government gas supervision and management platform in response to determining that the composite value at risk of at least one sub-period does not satisfy the preset evaluation condition. The second feedback instruction may include a transportation delay duration. The mode of execution of the second feedback instruction may be similar to the manner of execution of the execution instruction, which may be found in the related descriptions of the execution instruction.

The transportation delay duration refers to a duration to delay execution of a transportation task corresponding to the candidate transportation request. For example, the transportation delay duration may be the maximum time between a target sub-period and the current time The target sub-period refers to a sub-period of which the composite value at risk is maximum and is not less than the second risk threshold. For example, the sub-periods may be 0-30 minutes in the future, 30-35 minutes in the future, 35-40 minutes in the future, and 40-60 minutes in the future. The composite value at risk of the sub-period corresponding to the 35-40 minutes in the future may be maximum and may not be less than the second risk threshold, and the transportation delay duration may be 40 minutes.

When the composite value at risk of the sub-period is not less than the second risk threshold, the second feedback instruction that includes the transportation delay duration can be generated, and the candidate transportation request can be executed after avoiding the sub-period, thereby reducing the risk of gas transportation.

FIG. 5 is a schematic diagram illustrating an exemplary temporal model according to some embodiments of the present disclosure.

In some embodiments, a government gas supervision and management platform may predict, based on a candidate transportation request 510, gas transportation parameters 520 of a currently supervised vehicle, road information 530 corresponding to the currently supervised vehicle, and a traffic volume 540 of a gas transportation route corresponding to the currently supervised vehicle, a remaining temporal sequence 570 of the currently supervised vehicle through a temporal model 560. The temporal model 560 may be a machine learning model.

More descriptions regarding the candidate transportation request 510, the gas transportation parameters 520 of the currently supervised vehicle, and the road information 530 corresponding to the currently supervised vehicle may be found in FIG. 4 and related descriptions thereof.

The traffic volume 540 of the gas transportation route corresponding to the currently supervised vehicle refers to a count of vehicles that pass the road of the corresponding gas transportation route per unit of time, such as a count of vehicles that pass the road of the transportation route within one minute.

The temporal model 560 refers to a model configured to predict a remaining temporal sequence. In some embodiments, the temporal model 560 may be the machine learning model, such as a long short term memory recurrent neural network (LSTM) model, etc. In some embodiments, an input the temporal model 560 may include the candidate transportation request 510, the gas transportation parameters 520 of the currently supervised vehicle, the road information 530 corresponding to the currently supervised vehicle, and the traffic volume 540 of the gas transportation route corresponding to the currently supervised vehicle. In some embodiments, an output of the temporal model 560 may include the remaining temporal sequence 570 of the currently supervised vehicle.

More descriptions regarding the remaining temporal sequence 570 of the currently supervised vehicle may be found in FIG. 4 and related descriptions thereof.

In some embodiments, the temporal model 560 may be trained by supervised learning. For example, a plurality of training samples with labels may be input into an initial temporal model. A loss function may be constructed from the labels and prediction results of the initial temporal model. Parameters of the initial temporal model may be iteratively updated based on the loss function via gradient descent or other methods. The model training may be completed when a preset condition is satisfied, and a trained temporal model may be obtained. The preset condition may be that the loss function converges, a count of iterations reaches a threshold, etc.

In some embodiments, the training samples may include a sample candidate transportation request, sample gas transportation parameters of a sample currently supervised vehicle, road information corresponding to the sample currently supervised vehicle, and a traffic volume of a gas transportation route corresponding to the sample currently supervised vehicle. The training labels may be determined based on historical actual remaining transportation time corresponding to the sample currently supervised vehicle.

In some embodiments, the input of the temporal model 560 may further include an estimated degree of risk 550 of each of a plurality of sub-sections of road corresponding to each of a plurality of distribution destinations of the gas transportation route corresponding to the currently supervised vehicle. More descriptions regarding the estimated degree of risk 550 of each of the plurality of sub-sections of road corresponding to each of the plurality of distribution destinations may be found in FIG. 4 and related descriptions thereof.

In some embodiments, if the input of the temporal model 560 further includes the estimated degree of risk 550 of each of the plurality of sub-sections of road corresponding to each of the plurality of distribution destinations, the training samples may include a historical degree of risk of each of the plurality of sub-sections of road corresponding to each of the plurality of distribution destinations. The historical degree of risk of each of the plurality of sub-sections of road may be determined based on historical actual accident conditions at historical transportation time. More descriptions may be found in the related descriptions of FIG. 2.

By inputting the estimated degree of risk 550 of each of the plurality of sub-sections of road corresponding to each of the plurality of distribution destinations into the temporal model 560, the indirect effect of risk on the route speed can be considered, and the accuracy of the prediction of the model can be improved.

In some embodiments, the estimated degree of risk 390 of each sub-section output by the risk prediction model 380 may be inputted into the temporal model 560 as the estimated degree of risk 550 of the sub-section corresponding to each of the plurality of distribution destinations. The risk prediction model 380 and the temporal model 560 may be obtained by joint training.

In some embodiments, joint training samples may include a sample gas transportation request, a density of buildings corresponding to a sample gas transportation route, weather data at the time of execution of the sample gas transportation request, composition information of transported gas based on the sample gas transportation request, a degree of road bumps corresponding to the gas transportation route, a storage volume of a transporting vehicle, gas transportation parameters of a sample currently supervised vehicle, road information corresponding to the sample currently supervised vehicle, and a traffic volume of the gas transportation route corresponding to the sample currently supervised vehicle. The labels may be determined based on historical actual remaining transportation time of the sample currently supervised vehicle corresponding to the training samples.

In some embodiments, the sample gas transportation request, the density of buildings corresponding to the sample gas transportation route, the weather data at the time of executing the sample gas transportation request, the composition information of the transported gas based on the sample gas transportation request, the degree of road bumps corresponding to the gas transportation route, and the storage volume of the transportation vehicle may be input into the initial risk prediction model to obtain the estimated degree of risk of each of the plurality of sub-sections of road output by the initial risk prediction model. Then the estimated degree of risk of each of the plurality of sub-sections of road, the sample gas transportation request, the gas transportation parameters of the sample currently supervised vehicle, the road information corresponding to the sample currently supervised vehicle, and the traffic volume of the gas transportation route corresponding to the sample currently supervised vehicle may be input into the initial temporal model to obtain the remaining temporal sequence output by the initial temporal model. The loss function may be constructed based on the sample labels and the remaining temporal sequence output by the initial temporal model. The parameters of the initial risk prediction model and the initial temporal model may be synchronously and iteratively updated until the preset condition is satisfied, and the trained risk prediction model 380 and the trained temporal model 560 may be obtained. The preset condition may be that the loss function converges, a count of iterations reaches a threshold, etc.

The parameters of the risk prediction model 380 and the temporal model 560 may be obtained through joint training, which is conducive to solving the problem of difficulty in obtaining the labels when the risk prediction model 380 and the temporal model 560 are trained separately. Meanwhile, the estimated degree of risk of each of the plurality of sub-sections predicted by the risk prediction model 380 can be more in line with the input requirements of the temporal model 560, thereby improving the accuracy of the prediction results of the model.

By constructing and training the temporal model 560, the impacts of factors such as the candidate transportation request, the gas transportation parameters of the currently supervised vehicle, the road information corresponding to the currently supervised vehicle, and the traffic volume of the gas transportation route corresponding to the currently supervised vehicle on the remaining temporal sequence of the currently supervised vehicle can be explored, thereby improving the accuracy of predicting the remaining temporal sequence, saving the cost of manual determination of the remaining temporal sequence, and providing reliable data support for the subsequent process.

What is claimed is:

1. A method for transportation safety supervision based on smart gas, implemented by a government gas supervision and management platform, comprising:
determining an estimated degree of risk of a gas transportation request based on the gas transportation request uploaded by a gas company management platform, the gas transportation request including a gas transportation route, a transportation time, and a transportation volume;
in response to determining that the estimated degree of risk satisfies a preset risk condition, determining the gas transportation request as a candidate transportation request and generating a query instruction;
sending the query instruction to the gas company management platform for execution, the query instruction being configured to control at least one monitoring device controlled by the gas company management platform to obtain gas transportation parameters of a currently supervised vehicle and road information at a preset frequency; the gas transportation parameters including at least one of a total count of tasks and a vehicle location of a transporting vehicle;
determining a target transportation request based on the candidate transportation request, the gas transportation parameters of the currently supervised vehicle, and the road information corresponding to the currently supervised vehicle, and generating a target instruction, the target instruction including at least one of an execution instruction and an update instruction;
sending the target instruction to the gas company management platform for execution, the execution instruction being configured to execute the target transportation request, and the update instruction being configured to update the total count of tasks to obtain the latest total count of tasks;
adjusting the preset frequency based on the latest total count of tasks to obtain an adjusted frequency and sending the adjusted frequency to a government gas supervision object platform for execution;
in response to determining that a target vehicle exists and the road information corresponding to the target vehicle satisfies a preset road condition, adjusting the gas transportation route of the target vehicle to obtain an adjusted route and generating an adjustment instruction; and
sending the adjustment instruction to a gas equipment object platform for execution, the adjustment instruction being configured to control the target vehicle to execute the adjusted route.

2. The method of claim 1, wherein the gas transportation request further includes a speed threshold corresponding to the gas transportation route, the speed threshold being determined based on the transportation volume, composition information of transported gas, a degree of road bumps, and a storage volume of the transporting vehicle.

3. The method of claim 1, further comprising:
in response to determining that the estimated degree of risk does not satisfy the preset risk condition, generating a feedback instruction and sending the feedback instruction to the gas company management platform for execution, the feedback instruction being configured to notify an execution subject to upload a new gas transportation request.

4. The method of claim 1, wherein the gas transportation request includes a plurality of distribution destinations and a sub-distribution volume corresponding to each of the plurality of distribution destinations; one of the plurality of distribution destinations corresponding to one of a plurality of sub-sections of road; and
determining an estimated degree of risk of a gas transportation request based on the gas transportation request uploaded by a gas company management platform includes:
determining the estimated degree of risk of each of the plurality of sub-sections of road based on the gas transportation request.

5. The method of claim 4, wherein the determining the determining the estimated degree of risk of each of the plurality of sub-sections of road based on the gas transportation request includes:
determining the estimated degree of risk of each of the plurality of sub-sections of road based on the gas transportation request, a density of buildings corresponding to the gas transportation route, weather data in a future time period, the composition information of the gas, the degree of road bumps, and the storage volume of the transporting vehicle through a risk prediction model, the risk prediction model being a machine learning model.

6. The method of claim 5, wherein an input the risk prediction model includes a fuel addition location corresponding to the gas transportation route.

7. The method of claim 1, wherein the determining a target transportation request based on the candidate transportation request, the gas transportation parameters of the currently supervised vehicle, and the road information corresponding to the currently supervised vehicle includes:
predicting a remaining temporal sequence of the currently supervised vehicle based on the gas transportation parameters of the currently supervised vehicle;
dividing a future time period into a plurality of sub-periods based on the remaining temporal sequence and the candidate transportation request;
evaluating, for each of the plurality of sub-periods, a composite value at risk of the sub-period; and
in response to determining that the composite values at risk of all the sub-periods satisfy a preset evaluation condition, taking the candidate transportation request as the target transportation request.

8. The method of claim 7, wherein the predicting a remaining temporal sequence of the currently supervised vehicle based on the gas transportation parameters of the currently supervised vehicle includes:
predicting the remaining temporal sequence of the currently supervised vehicle based on the candidate transportation request, the gas transportation parameters of the currently supervised vehicle, the road information corresponding to the currently supervised vehicle, and a traffic volume of the gas transportation route corresponding to the currently supervised vehicle through a temporal model, the temporal model being a machine learning model.

9. The method of claim 8, wherein an input of the temporal model includes: an estimated degree of risk of each of a plurality of sub-sections of road corresponding to each of a plurality of distribution destinations.

10. The method of claim 9, wherein the temporal model is obtained based on joint training with a risk prediction model.

11. The method of claim 7, further comprising:
in response to determining that the composite value at risk of at least one of the plurality of sub-periods does not satisfy the preset evaluation condition, refusing to execute the candidate transportation request and generating a second feedback instruction; and
sending the second feedback instruction to the gas company management platform for execution, the second feedback instruction including a transportation delay duration.

12. An Internet of Things (IoT) system for transportation safety supervision based on smart gas, comprising a public user platform, a citizen cloud service platform, a government gas supervision and management platform, a government gas supervision sensor network platform, a government gas supervision object platform, a gas company sensor network platform, and a gas equipment object platform, wherein the government gas supervision object platform includes a gas company management platform;
the government gas supervision and management platform is configured to:
determine an estimated degree of risk of a gas transportation request based on the gas transportation request uploaded by the gas company management platform, the gas transportation request including a gas transportation route, a transportation time, and a transportation volume;
in response to determining that the estimated degree of risk satisfies a preset risk condition, determine the gas transportation request as a candidate transportation request and generate a query instruction;
send the query instruction to the government gas supervision object platform for execution, the query instruction being configured to control at least one monitoring device controlled by the gas company management platform to obtain gas transportation parameters of a currently supervised vehicle and road information at a preset frequency; the gas transportation parameters including at least one of a total count of tasks and a vehicle location of a transporting vehicle;
determine a target transportation request based on the candidate transportation request, the gas transportation parameters of the currently supervised vehicle, and the road information corresponding to the currently supervised vehicle, and generate a target instruction, the target instruction including at least one of an execution instruction and an update instruction;
send the target instruction to the gas company management platform for execution, the execution instruction being configured to execute the target transportation request, and the update instruction being configured to update the total count of tasks to obtain the latest total count of tasks;
adjust the preset frequency based on the latest total count of tasks to obtain an adjusted frequency and send the adjusted frequency to the government gas supervision object platform for execution;
in response to determining that a target vehicle exists and the road information corresponding to the target vehicle satisfies a preset road condition, adjust the gas transportation route of the target vehicle to obtain an adjusted route and generate an adjustment instruction; and
send the adjustment instruction to the gas equipment object platform for execution, the adjustment instruction being configured to control the target vehicle to execute the adjusted route.
the gas company management platform is configured to:
obtain the gas transportation request:
execute the query instruction to control the at least one monitoring device to obtain the gas transportation parameters of the currently supervised vehicle and the road information at the preset frequency; and
execute the target instruction to execute the target transportation request and update the total count of tasks to obtain the latest total count of tasks; wherein
the gas company senso network platform is configured to transmit the adjustment instruction to the gas equipment object platform; and
the gas equipment object platform is configured to control the target vehicle to execute the adjusted route.

13. The IoT system of claim 12, wherein the gas transportation request further includes a speed threshold corresponding to the gas transportation route, the speed threshold being determined based on the transportation volume, composition information of transported gas, a degree of road bumps, and a storage volume of the transporting vehicle.

14. The IoT system of claim 12, wherein the government gas supervision and management platform is further configured to:
in response to determining that the estimated degree of risk does not satisfy the preset risk condition, generate a feedback instruction and send the feedback instruction to the gas company management platform for execution, the feedback instruction being configured to notify an execution subject to upload a new gas transportation request.

15. The IoT system of claim 12, wherein the gas transportation request includes a plurality of distribution destinations and a sub-distribution volume corresponding to each of the plurality of distribution destinations; one of the plurality of distribution destinations corresponding to one of the plurality of sub-sections of road; and
the government gas supervision and management platform is further configured to:
determine the estimated degree of risk of each of the plurality of sub-sections of road based on the gas transportation request.

16. The IoT system of claim 15, wherein the government gas supervision and management platform is further configured to:
determine the estimated degree of risk of each of the plurality of sub-sections of road based on the gas transportation request, a density of buildings corresponding to the gas transportation route, weather data in a future time period, the composition information of the gas, the degree of road bumps, and the storage volume of the transporting vehicle through a risk prediction model, the risk prediction model being a machine learning model.

17. The IoT system of claim 16, wherein an input the risk prediction model includes a fuel addition location corresponding to the gas transportation route.

18. The IoT system of claim 12, wherein the government gas supervision and management platform is further configured to:
predict a remaining temporal sequence of the currently supervised vehicle based on the gas transportation parameters of the currently supervised vehicle;
divide a future time period into a plurality of sub-periods based on the remaining temporal sequence and the candidate transportation request;
evaluate, for each of the plurality of sub-periods, a composite value at risk of the sub-period; and
in response to determining that the composite value at risks of all the sub-periods satisfy a preset evaluation condition, take the candidate transportation request as the target transportation request.

19. The IoT system of claim 18, wherein the government gas supervision and management platform is further configured to:
predict the remaining temporal sequence of the currently supervised vehicle based on the candidate transportation request, the gas transportation parameters of the currently supervised vehicle, the road information corresponding to the currently supervised vehicle, and a traffic volume of the gas transportation route corresponding to the currently supervised vehicle through a temporal model, the temporal model being a machine learning model.

20. The IoT system of claim 19, wherein an input of the temporal model includes: an estimated degree of risk of each of a plurality of sub-sections of road corresponding to each of a plurality of distribution destinations.
